(19) United States
(12) Patent Application Publication
(10) Pub. No.: US 2005/0237026 A1
(43) Pub. Date: Oct. 27, 2005

(54) Surface charge removal apparatus and method

(75) Inventors: Steven Hall, Bury (GB); Christopher Kenneth Moore, Bury (GB)

Correspondence Address: Adams Evans P.A., 2180 Two Wachovia Center, 301 S. Tryon Street, Charlotte, NC, 28282, US

(73) Assignee: PARAGON CONTROLS (UNITED KINGDOM) LIMITED, Bury (GB)

(21) Appl. No.: 10/922,289

(22) Filed: Aug. 19, 2004

(30) Foreign Application Priority Data
Apr. 26, 2004 (GB) GB 0409114.6

(51) Int. Cl. H02J 7/00

(52) U.S. Cl. 320/130

(57) ABSTRACT

Apparatus for connection to a battery for dissipating surface charge. A load is provided for dissipating surface charge. The load is temporarily connected to the battery for a period of time determined by a timer. Also disclosed is a method for dissipating surface charge.

### TECHNICAL FIELD AND BACKGROUND OF THE INVENTION

The present invention relates to an apparatus and associated method for addressing problems experienced with batteries of the so-called ‘wet’ type, such as lead-acid batteries used in vehicles.

Surface charge is caused by an uneven mix of sulphuric acid and water along the surface of the lead plates inside a battery. The uneven mix can occur as a result of the charging and/or discharging process.

The presence of surface charge can make determining the actual charge status of a battery difficult. The presence of surface charge can result in erroneous readings.

In a particular problem encountered in the motor vehicle industry, vehicles have their battery tested by a digital battery analyser, which can produce an erroneous reading due to the presence of surface charge. Other types of battery analysers may also be used, such as voltmeters or multimeters.

A common solution to this problem is to dispatch the ‘faulty’ battery to a remote service centre, at some considerable expense. As the battery is inevitably agitated during transit, the mixture of sulphuric acid and water becomes less uneven, which reduces the effect of the surface charge or even removes it altogether. The ‘faulty’ battery is thus declared normally operational and re-sent to the original service centre at further considerable cost.

This is clearly unsatisfactory and embodiments of the present invention aim to address problems with certain prior art battery test procedures and instruments.

### SUMMARY OF THE INVENTION

According to a first aspect of the present invention there is provided Apparatus for connection to a battery for dissipating surface charge, comprising: a load for dissipating surface charge; a timer; wherein the load is temporarily connected to the battery for a period of time determined by the timer.

Preferably, the apparatus further comprises: a voltage sensor for sensing a terminal voltage of the battery and, if the terminal voltage exceeds a predetermined level, the apparatus is operable to temporarily connect the load to the battery until such time as the terminal voltage reaches the predetermined level. This provides the advantageous effect that if the subject battery has been recently charged, such that its terminal voltage exceeds the expected level, it can still benefit from use of embodiments of the invention.

Preferably, the apparatus comprises reverse-polarity protection circuitry to protect the apparatus in the event that the battery connections are transposed.

Preferably, the apparatus further comprises a suitably programmed microprocessor for controlling the operation of the apparatus. Such a microprocessor may further include separate memory for storing and/or executing a control program.

Preferably, the apparatus further comprises a cooling fan arranged to cool the load. The fan may be arranged to be operational for the entire time that the apparatus is connected to a battery or, alternatively, may be switched on and/or off in a controlled manner.

Preferably, the load comprises a resistive load. The resistive load may comprise one or more resistors arranged to dissipate energy from the battery.

Preferably, the apparatus comprises indicators for displaying the operational status of the apparatus. Such indicators may indicate the presence of a suitable power source and/or the state of a discharge cycle.

According to a second aspect of the present invention there is provided a method of operating a device for dissipating surface charge in a battery, comprising the steps of: connecting the device to the battery terminals; and initiating a controlled partial discharge of the battery for a predetermined time period by temporarily connecting the battery to a load.

Preferably, the method further comprises the step of sensing a battery terminal voltage before initiating the controlled partial discharge.

Preferably, if the sensed voltage is higher than a predetermined level, the load is connected to the battery until the sensed terminal voltage reaches the predetermined level, before continuing with the discharge for the predetermined time period.

Preferably, the method involves the use of an apparatus according to the first aspect of the invention.

Embodiments of the invention offer several advantages over prior art solutions. Specifically, they allow for a quick and simple conditioning of a suspect battery to be performed before any battery analysis, which might otherwise yield an erroneous result, is carried out.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a representation of an embodiment of the invention attached to a battery; and

FIG. 2 shows a schematic block diagram of the functional parts of an embodiment of the invention.

### DETAILED DESCRIPTION OF THE PREFERRED EMBODIMENT AND BEST MODE

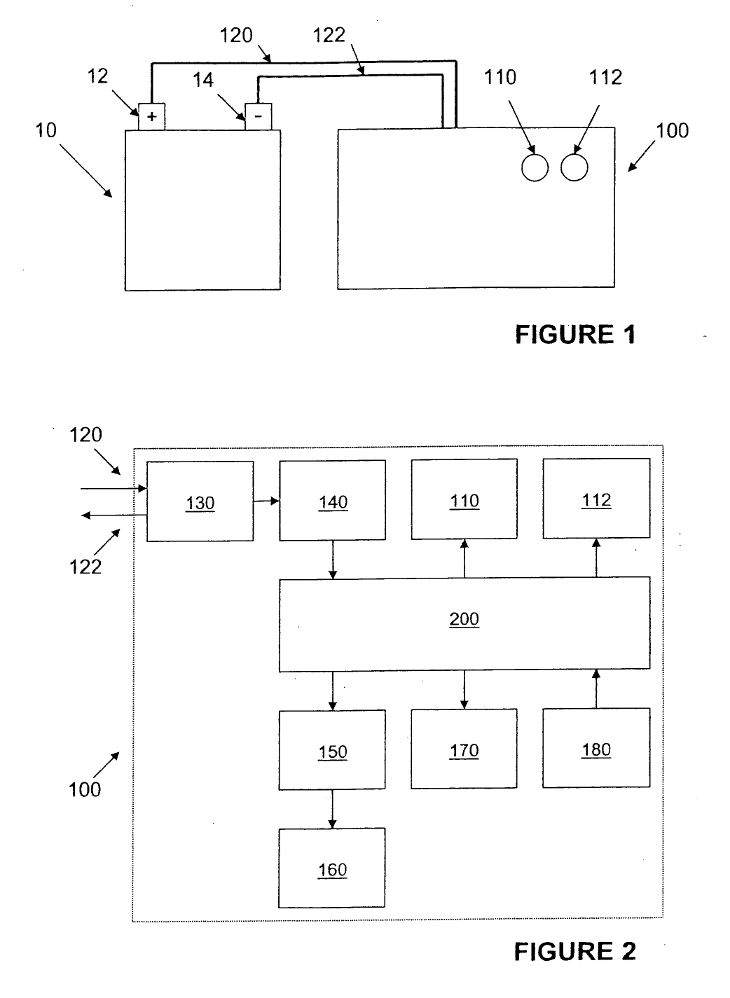

FIG. 1 shows how apparatus 100, according to an embodiment of the invention, may be connected to a battery 10. The battery in this instance is a lead-acid vehicle battery having a positive terminal 12 and a negative terminal 14.

The apparatus 100 is connected to the positive and negative terminals 12, 14 of the battery 10 via two flying leads 120, 122 respectively. The flying leads are suitably terminated in crocodile clips or other connectors. The leads and/or the terminating clips may be colour-coded or otherwise marked to indicate the correct connection polarity.

The apparatus 100 has two indicator LEDs 110 and 112 visible on its outer surface. They provide details of the operation of the apparatus and will be described in more detail shortly.

In use, the apparatus 100 is attached to a battery 10. The apparatus 100 is entirely powered from the battery 10 and has no internal power source.

The basic purpose of the apparatus 100 is to slightly discharge the battery 10, in a controlled fashion, so that any surface charge which has accumulated during charging is dissipated, thus allowing an accurate reading of the battery voltage to be taken.

In effect, the presence of surface charge can make the battery terminal voltage appear higher than would be the case in the absence of surface charge.

Embodiments of the invention therefore act to dissipate the surface charge in a controlled manner so that any subsequent reading of the battery voltage indicates a true value.

Once the apparatus 100 is connected to the battery, a partial discharge cycle is commenced. This is indicated by red LED 110 being illuminated continuously, and the green LED 112 flashing. Once the discharge cycle is completed, the red LED 110 remains on and the green LED 112 is illuminated continuously to indicate that the unit's operation is complete. An operator may then disconnect the unit 100 from the battery 10. If required, the voltage of the battery may be tested by a battery analyser to confirm that the battery does indeed exhibit the correct voltage.

By reference to FIG. 2, it can be seen that apparatus 100 is composed of several functional blocks. At the heart of the unit is a programmable microprocessor. Any suitable microprocessor or microcontroller may be used.

The apparatus 100 connects to a battery 10 via flying leads 120 and 122. These leads are connected to a reverse polarity protection circuit 130, which is further connected to an overload protection device 140. A suitable device includes a fuse. The reverse polarity protection circuit includes a readily available component which protects the circuitry of the apparatus from being damaged by accidental connection of the flying leads 120, 122 to the wrong battery terminals 12, 14. The overload protection device 140 protects the circuitry in the event of a connection being made to a higher voltage battery than specified for the unit 100.

Power for the unit 100 is sourced from the battery 10 via the flying leads 120, 122, the reverse polarity protection device 130 and the fuse 140. In cases where the battery is unable to deliver sufficient power to power the unit 100, then it needs charging anyway, and the use of unit 100 would be inappropriate.

The microprocessor 200, upon being connected to a power source 10, executes a program which controls a partial discharge of the battery 10. The microprocessor first illuminates red LED 110 and causes the green LED 112 to flash.

At the same time, the battery is connected to a discharge load 160, consisting of one or more resistors. A typical configuration for the resistors is five 15 Ohm resistors, each rated at 50W, arranged in parallel. The discharge load 160 is protected by a thermal cutout 150 which acts to disconnect the power to the load 160 if the temperature of the load exceeds a preset threshold.

Also provided to assist in temperature regulation of the unit 100 is a cooling fan 170 which assists in the forced-air cooling of the load 160.

The controlled discharge of the battery 10 continues until the voltage at the battery terminals, sensed by voltage sensor 180 reaches a pre-determined level.

In a typical instance, the unit 100 is connected to a battery 10 immediately following a charging operation, when the problem of surface charge is likely to be at its worst. A typical vehicle battery has a terminal voltage in the range of 12.6 to 12.8V. For the sake of argument, a typical value of 12.7V will be assumed here, but different values can obviously be used in different embodiments.

A freshly charged vehicle battery may exhibit a terminal voltage higher than the 12.7V expected, and may be in the range 13.5 to 14.0V. This higher than expected value may cause the battery to fail a battery analysis test.

If, however, the battery is connected to unit 100, the unit detects the voltage level in voltage sensor 180. If the voltage is higher than 12.7V, then the load 160 is connected into circuit and discharge commences. The load 160 remains connected to the battery until the monitored voltage reaches 12.7V. At this point, the load remains connected for a further period of time, e.g. 1 minute, before being disconnected. After the load is disconnected, the fan 170 may stay running for a further short period e.g. 2 minutes to ensure that the load 160 is cooled.

In the case of a battery which has not been recently charged, it may still suffer from a problem with surface charge. In such a case, when the unit 100 is attached to the battery 10, the battery terminal voltage is likely to be lower than 12.7V. In such cases, the discharge cycle is initiated, and continues as in the previous example, except that as the battery voltage is already below 12.7 V, the discharge cycle is maintained for 1 minute, followed by a further 2 minutes of fan 170 operation.

Once the battery has been through the controlled partial-discharge cycle, then it is assumed that all surface charge has been dissipated in the load 160, and that any subsequent reading of the battery voltage using a regular battery analyser will indicate the true voltage of the battery.

Use of embodiments of the invention offer the advantage of reducing the number of batteries which would otherwise be rejected as ‘out of specification’ and returned to a service centre or otherwise rendered temporarily unavailable. Embodiments of the invention can be constructed using readily available components at a relatively low cost, and provide a cost-effective solution to the problems encountered with prior art battery testing and charging systems as described.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. Apparatus for connection to a battery for dissipating surface charge, comprising:
(a) a load for dissipating surface charge; and
(b) a timer operatively associated with the load for temporarily connecting the load to the battery for a period of time determined by the timer.

2. Apparatus as claimed in claim 1 wherein the apparatus further comprises:
a voltage sensor for sensing a terminal voltage of the battery and upon the terminal voltage exceeding a predetermined level, the apparatus operates to temporarily connect the load to the battery until such time as the terminal voltage reaches the predetermined level.

3. Apparatus as claimed in claim 1 or 2 wherein the apparatus comprises reverse-polarity protection circuitry to protect the apparatus in the event that the battery connections are transposed.

4. Apparatus as claimed in claim 3 wherein the apparatus further comprises a suitably programmed microprocessor for controlling the operation of the apparatus.

5. Apparatus as claimed in claim 1, wherein the apparatus further comprises a cooling fan arranged to cool the load.

6. Apparatus as claimed in claim 1, wherein the load comprises a resistive load.

7. Apparatus as claimed in claim 1, wherein the apparatus comprises indicators for displaying the operational status of the apparatus.

8. A method of dissipating surface charge in a battery, comprising the steps of:
(a) providing a load that is operatively associated with the battery for being switched between connected and disconnected positions relative to the battery terminals; and
(b) initiating a controlled partial discharge of the battery for a predetermined time period by temporarily connecting the battery to the load.

9. A method as claimed in claim 8; and further comprising the step of sensing a battery terminal voltage before initiating the controlled partial discharge.

10. A method as claimed in claim 9 wherein if the sensed voltage is higher than a predetermined level, the load is connected to the battery until the sensed terminal voltage reaches the predetermined level, before continuing with the discharge for the predetermined time period.
